(19) United States
(12) Patent Application Publication
(10) Pub. No.: US 2013/0271510 A1
(43) Pub. Date: Oct. 17, 2013

(54) AUTOSTEREOSCOPIC DISPLAY APPARATUS

(71) Applicant: JVC Kenwood Corporation, Yokohama-shi (JP)

(72) Inventor: Shigeru MATSUMOTO, Yokohama-shi (JP)

(21) Appl. No.: 13/917,179

(22) Filed: Jun. 13, 2013

Related U.S. Application Data
(63) Continuation of application No. PCT/JP2011/078957, filed on Dec. 14, 2011.

(30) Foreign Application Priority Data
Dec. 17, 2010 (JP) 2010-282030

(51) Int. Cl. G09G 5/02

(52) U.S. Cl. CPC G09G 5/02
USPC 345/690; 345/55

(57) ABSTRACT

An autostereoscopic display apparatus includes: a display panel displaying an image by using light beams from color pixels; and a parallax division part disposed to face the display panel. The parallax division part divides a color pixel region of the display panel into a right-eye color pixel region RG visible to the right eye but invisible to the left eye and a left-eye color pixel region LG visible to the left eye but invisible to the right eye, so that different images are visible respectively from the right eye and the left eye. Color pixels BG outputting no light beams are arranged in a boundary between the right-eye color pixel region RG and the left-eye color pixel region LG. An arrangement direction of the color pixels BG outputting no light beams is inclined.

### CROSS REFERENCE TO RELATED APPLICATION

This application is a Continuation of PCT Application No. PCT/JP2011/078957, filed on Dec. 14, 2011, and claims the priority of Japanese Patent Application No. 2010-282030, filed on Dec. 17, 2010, the contents of both of which are incorporated herein by reference.

### BACKGROUND

The present invention relates to an autostereoscopic display apparatus of a parallax division method.

There is known a stereoscopic image display apparatus which divides an image displayed on a display panel such as a liquid crystal panel in multiple viewpoint directions by using a special optical member such as a lenticular sheet or a slit-type parallax barrier and thereby causes a viewed image to change depending on a viewing position. Specifically, a color pixel region of the display panel is divided into a right-eye color pixel region visible only to the right eye of an viewer and a left-eye color pixel region visible only to the left eye of the viewer, so that different images can be viewed respectively from the positions of the right eye and the left eye arranged in the horizontal direction. In this way, an autostereoscopic display apparatus allowing stereoscopic viewing without glasses can be achieved (see Patent Document 1: Japanese Patent Application Publication No. 2010-181900 and Patent Document 2: Japanese Patent Application Publication No. 2005-331844).

In an autostereoscopic display apparatus of Patent Document 1, in a display element including pixel regions alternately formed for the left eye and the right eye, a light-beam non-transmitting region is formed in a boundary portion between each adjacent pair of the pixel region for the left eye and the pixel region for the right eye (see paragraph 0027). The Patent Document 1 states that an image with no left and right crosstalk can be thereby viewed even when the head of the viewer moves upward and downward (see paragraph 0029).

The parallax division method includes, in addition to a two-view method, a multi-view method, a super-multi-view method, and an integral imaging method (II method). Patent Document 2 describes an invention capable of three-dimensionally displaying images of the two-view method, the multi-view method, and the like, in the II method. The Patent Document 2 states that, in order to prevent crosstalk of left and right parallax component images, a black (or monochromatic) pixel row is interposed between the left and right parallax component images and, particularly in the case of the two-view method, pixels rows in both unnecessary end portions of element image boundaries are set to be black (see paragraph 0047).

As described above, there has been known such a technique that a region with nothing displayed is formed in the boundary between the left and right parallax images to suppress crosstalk and to increase the viewing range in which stereoscopic viewing is possible, the crosstalk occurring when the view point of the viewer moves and being a phenomenon in which images for the left eye and the right eye are mixed into each other.

### SUMMARY

In the two-view method of forming two parallax views in one dimensional direction of the horizontal direction, left-eye color pixel regions and right-eye color pixel regions each form a row extending in the vertical direction and are arranged alternately in a stripe pattern. Accordingly, when stereoscopic viewing in the two-view method is performed by using a display panel in which color pixels of different colors are periodically arranged in the horizontal direction and color pixels of the same color are arranged in the vertical direction, the color pixels of the same color are arranged in the vertical direction in the boundary between each adjacent pair of the left-eye color pixel region and the right-eye color pixel region. The two-view method has such a problem that, when the viewpoint of the viewer moves and crosstalk occurs, a monochromatic linear noise is visible.

The present invention has been made in view of the problem described above and an object thereof is to suppress occurrence of crosstalk due to moving of a viewpoint and to suppress occurrence of a monochromatic linear noise even if crosstalk should occur.

In order to achieve the object described above, the present invention is summarized, in one embodiment thereof, as an autostereoscopic display apparatus including: a display panel (12) configured to display an image by using light beams outputted from multiple color pixels; and a parallax division part (13) disposed to face a display surface of the display panel (12). In the display panel (12), the color pixels of different colors are periodically arranged in a horizontal direction (HD) and the color pixels of the same color are arranged in a vertical direction (VD). The parallax division part (13) divides a color pixel region of the display panel (12) into a right-eye color pixel region (RG) visible to the right eye (RE) of a viewer but invisible to the left eye (LE) of the viewer and a left-eye color pixel region (LG) visible to the left eye (LE) but invisible to the right eye (RE), so that different images can be viewed respectively from positions of the right eye (RE) and the left eye (LE) arranged in the horizontal direction. Color pixels (BG) outputting no light beams are arranged in a boundary between the right-eye color pixel region (RG) and the left-eye color pixel region (LG). Moreover, an arrangement direction of the color pixels (BG) outputting no light beams is inclined.

Here, a parallax barrier and a lenticular sheet are included in the “parallax division part”.

In the one embodiment described above, the arrangement direction of the color pixels (BG) outputting no light beams may be inclined at a ratio of one pitch in the horizontal direction (HD) of the color pixels to one pitch in the vertical direction (VD) of the color pixels. In this case, in a color pixel row arranged along edges of the color pixels (BG) outputting no light beam, no color pixels of the same color are adjacent to each other and the color pixels of different colors are periodically arranged in a unit of one color pixel. Accordingly, occurrence of a linear noise and disturbance of the white balance can be further suppressed.

Alternatively, in the one embodiment described above, the arrangement direction of the color pixels (BG) outputting no light beams may be inclined at a ratio of one pitch in the horizontal direction (HD) of the color pixels to two pitches in the vertical direction (VD) of the color pixels. In this case, since the arrangement direction of the color pixels (BG) outputting no light beams is closer to the vertical direction (VD), the vertical-direction width of the color pixels BG outputting no light beams is increased. Accordingly, crosstalk in the vertical direction is reduced and the viewing range in the vertical direction in which stereoscopic viewing is possible is increased.

In the autostereoscopic display apparatus of the present invention, since the arrangement direction of the color pixels outputting no light beams is inclined, no color pixels of the same color are arranged side by side along the edges of the color pixels outputting no light beam. Accordingly, it is possible to suppress a linear noise occurring when the color pixels outputting no light beams are arranged in the vertical direction which is the same as the arrangement direction of the color pixels of the same color. Hence, it is possible to suppress occurrence of crosstalk due to moving of the viewpoint and to suppress occurrence of a monochromatic linear noise even if crosstalk should occur.

### BRIEF DESCRIPTION OF DRAWINGS

FIG. 1 is a cross-sectional view showing an overall configuration of an autostereoscopic display apparatus in an embodiment of the present invention.

FIG. 2 is a schematic view for explaining a method of performing parallax division at positions of the left eye LE and the right eye RE by using a liquid crystal barrier 13, part (a) of FIG. 2 shows a case where there are no color pixels BG outputting no light beams, and part (b) of FIG. 2 shows a case where there are color pixels BG outputting no light beams.

FIG. 3 is a plan view showing a color pixel region included in the LCD panel 12.

FIG. 4 is a plan view showing an arrangement of right-eye color pixel regions RG visible to the right eye RE, left-eye color pixel regions LG visible to the left eye LE, and the color pixels BG outputting no light beams, in the color pixel region of the LCD panel 12 shown in FIG. 3.

FIG. 5 is a plan view showing a case where an arrangement direction of the color pixels BG outputting no light beams is inclined at a ratio of one pitch in a horizontal direction of the color pixels to two pitches in the vertical direction of the color pixels.

FIG. 6 is a plan view showing a comparative example where, in the color pixel region shown in FIG. 3, the right-eye color pixel regions RG, the left-eye color pixel regions LG, and the color pixels BG outputting no light beams are arranged in the vertical direction.

Part (a) of FIG. 7 is a schematic view showing a two-view parallax division method according to a parallax barrier method and Part (b) of FIG. 7 is a schematic view showing a two-view parallax division method according to a lenticular method.

### DETAILED DESCRIPTION

An embodiment of the present invention is described below with reference to the drawings. In descriptions of the drawings, the same parts are denoted by the same reference numerals and explanations thereof are omitted.

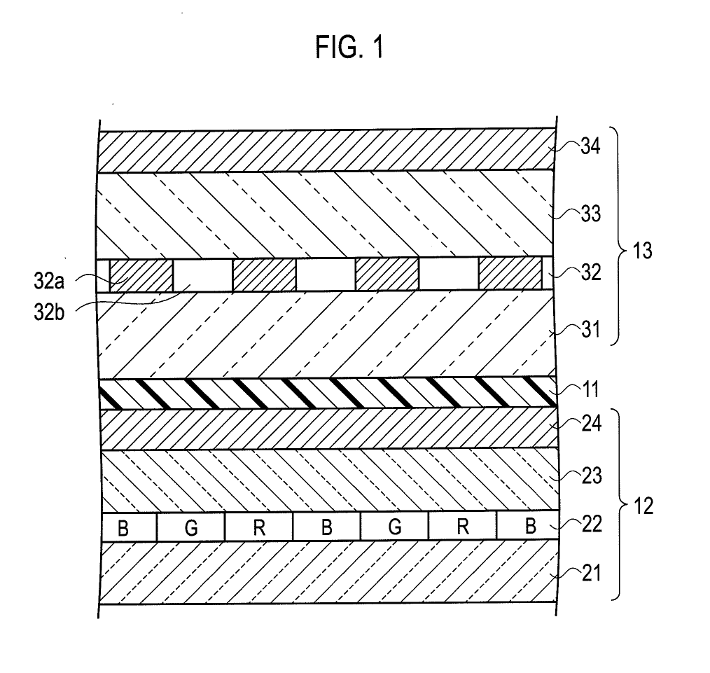

First, an overall configuration of an autostereoscopic display apparatus in the embodiment of the present invention is described with reference to FIG. 1. FIG. 1 shows a cut section of the autostereoscopic display apparatus in a horizontal direction. The autostereoscopic display apparatus includes a LCD (liquid crystal display) panel 12 as an example of a display panel and a liquid crystal barrier 13 as an example of a parallax division part disposed to face a display surface of the LCD panel 12. The LCD panel 12 and the liquid crystal barrier 13 are adhered to each other by an adhesive sheet 11.

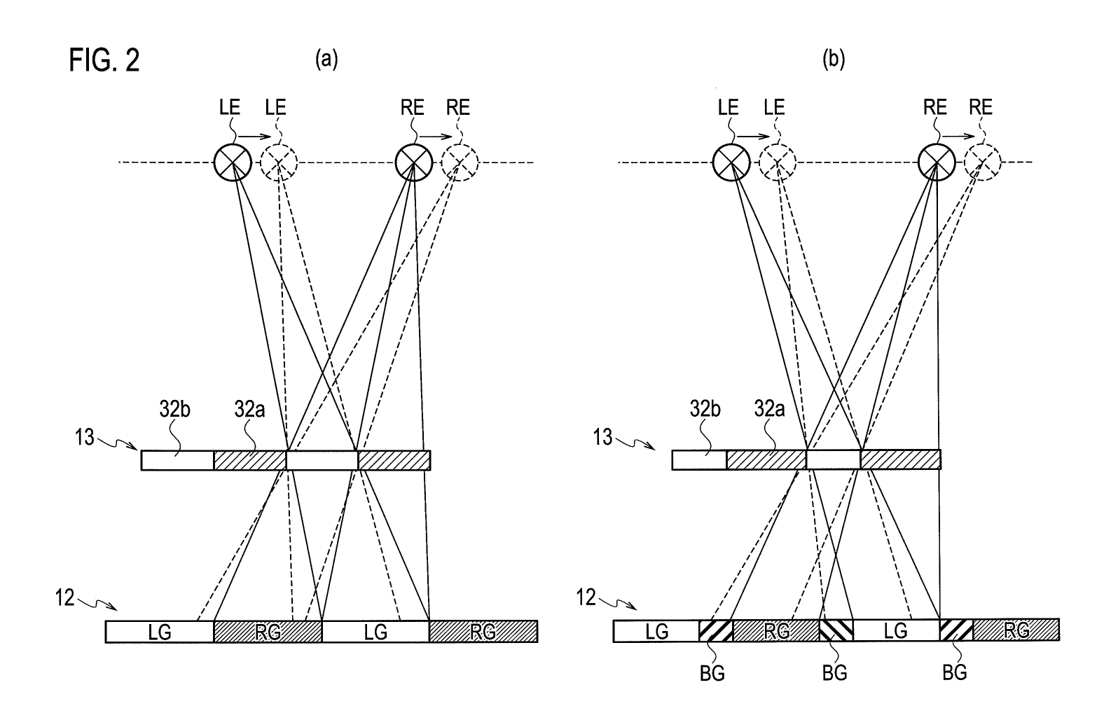

In the LCD panel 12, both surfaces of a liquid crystal layer 22 are interposed between LCD grass substrates 21, 23 and a color filter (not illustrated) is formed on the LCD glass substrate 23 on the display surface side. Colored layers of different colors of red (R), green (G), and blue (B) are arranged in matrix in a main surface of the color filter. The arrangement of the colored layers corresponds to an arrangement of color pixels of LCD panel 12. The arrangement of the color pixels included in the LCD panel 12 is described later with reference to a plan view of FIG. 2. A LCD polarizing plate 24 is stacked on the display surface side of the LCD glass substrate 23. A back light (not illustrated) is arranged on a back surface side of the LCD glass substrate 21.

The liquid crystal barrier 13 is an example of a parallax barrier and can form a pattern of a barrier portion blocking light, by using a passive type liquid crystal system or an active matrix type liquid crystal system. In the liquid crystal barrier 13, both surfaces of a barrier liquid crystal layer 32 are interposed between liquid crystal barrier glass substrates 31, 33. A liquid crystal barrier polarizing plate 34 is stacked on the display surface side of the liquid crystal barrier glass substrate 33. In the barrier liquid crystal layer 32, barrier portions 32a configured to block light and slit portions 32b configured to transmit light are alternately formed.

As shown in part (a) of FIG. 2, right-eye color pixel regions RG of the LCD panel 12 visible from the right eye RE of a viewer through the slit portions 32b are shielded by the barrier portions 32a from the left eye LE of the viewer and are thus not visible. Meanwhile, left-eye color pixel regions LG of the LCD panel 12 visible from the left eye LE of the viewer through the slit portions 32b are shielded by the barrier portions 32a from the right eye RE of the viewer and are thus not visible. As described above, the liquid crystal barrier 13 divides the color pixel region of the LCD panel 12 into the right-eye color pixel regions RG visible to the right eye RE but invisible to the left eye LE and the left-eye color pixel regions LG visible to the left eye LE but invisible to the right eye RE. The viewer can thus view different images from the positions of the right eye RE and the left eye LE arranged in the horizontal direction. In other words, stereoscopic viewing is made possible by dividing an image on the LCD panel 12 in multiple viewpoint directions and thereby causing viewed image to change depending on the viewing positions.

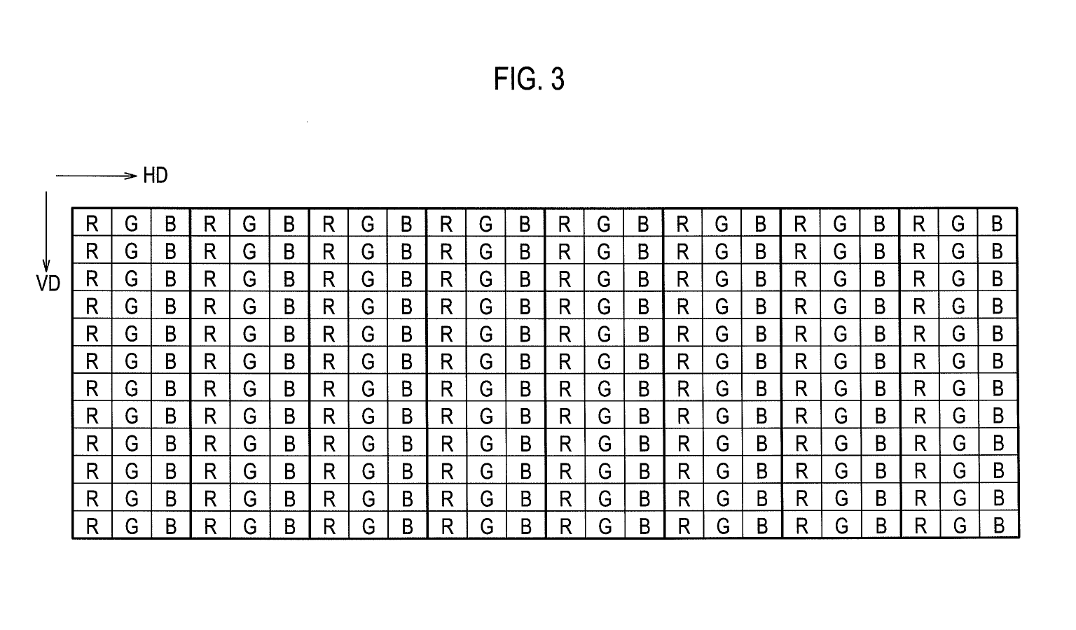

Next, an arrangement of the color pixels included in the LCD panel 12 is described with reference to FIG. 3. Here, the description is given by using, as an example, the LCD panel 12 including the color pixels of three different colors, red (R), green (G), and blue (B). Each of boxes denoted by “R” shows a unit color pixel of red (R), each of boxes denoted by “G” shows a unit color pixel of green (G), and each of boxes denoted by “B” shows a unit color pixel of blue (B). The LCD panel 12 displays an image by using light beams outputted from these color pixels.

The color pixels of three different colors, red (R), green (G), and blue (B) are periodically arranged in a horizontal direction HD. Moreover, the color pixels of the same color of one of red (R), green (G), and blue (B) are arranged in each row in a vertical direction VD. The entire region shown in FIG. 3 in which the color pixels are formed is referred to as “color pixel region” of the LCD panel 12. Note that, in FIG. 3, an illustration of a black matrix BM formed between adjacent color pixels is omitted and an aspect ratio of each unit color pixel is different from the actual one.

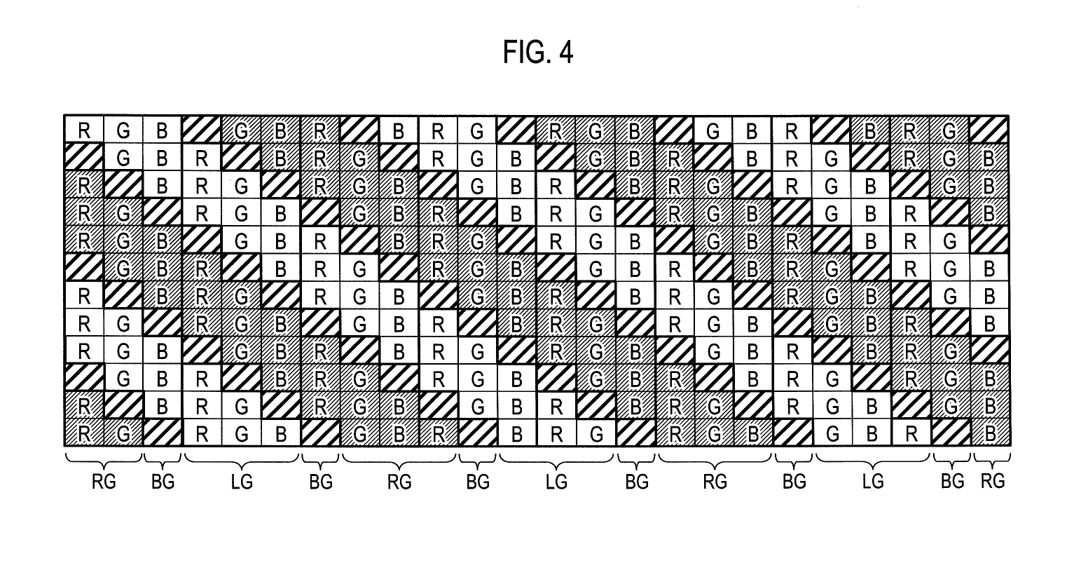

Referring to FIG. 4, a description is given of an arrangement of the right-eye color pixel regions RG visible to the right eye RE, the left-eye color pixel regions LG visible to the left eye LE, and color pixels BG outputting no light beams, in the color pixel region of the LCD panel 12 shown in FIG. 3. The right-eye color pixel regions RG and the left-eye color pixel regions LG are each a strip-shaped region having a width equal to three color pixels in the horizontal direction and are regions extending parallel to each other in an inclined direction. Moreover, the right-eye color pixel regions RG and the left-eye color pixel regions LG are alternately arranged in a stripe pattern and the color pixels BG outputting no light beams are arranged in a boundary between each adjacent pair of the right-eye color pixel region RG and the left-eye color pixel region LG. The color pixels BG outputting no light beams are arranged in the same inclined direction as the shapes of the right-eye color pixel regions RG and the left-eye color pixel regions LG. In the example of FIG. 4, the arrangement of the color pixels BG outputting no light beams has a width of one color pixel in the horizontal direction. The arrangement direction of the color pixels BG outputting no light beams is inclined at a ratio of one pitch in the horizontal direction of the color pixels to one pitch in the vertical direction of the color pixels.

Although an illustration is omitted, the barrier portions 32a and the slit portions 32b of the barrier liquid crystal layer 32 each have a strip shape extending parallel to each other in the inclined direction to correspond with the arrangement of the right-eye color pixel regions RG and the left-eye color pixel regions LG. The arrangement direction of the barrier portions 32a and the slit portions 32b is inclined at a ratio of one pitch in the horizontal direction of the color pixels to one pitch in the vertical direction of the color pixels.

Aligning the barrier portions 32a and the slit portions 32b of the barrier liquid crystal layer 32 with the LCD panel 12 shown in FIG. 4 can cause the image on the LCD panel 12 to be divided in the multiple viewpoint directions and thereby cause the viewed image to change depending on the viewing positions as shown in FIG. 2.

Referring to parts (a) and (b) of FIG. 2, a description is given of reduction of crosstalk and an increase of a viewing range of stereoscopic viewing which are achieved by insertion of the color pixels BG outputting no light beams.

Part (a) of FIG. 2 shows a case where the color pixels BG outputting no light beams are not inserted between each adjacent pair of the right-eye color pixel region RG and the left-eye color pixel region LG. When the head of the viewer moves in the horizontal direction and the positions of the left eye LE and the right eye RE thereby move as shown in part (a) of FIG. 2, part of the right-eye color pixel region RG becomes visible to the left eye LE and part of the left-eye color pixel region LG becomes invisible to the left eye LE. Similarly, part of the left-eye color pixel region LG becomes visible to the right eye RE and part of the right-eye color pixel region RG becomes invisible to the right eye RE. The image for the left eye and the image for the right eye thus mix into each other and crosstalk thereby occurs.

On the contrary, part (b) of FIG. 2 shows a state where the color pixels BG outputting no light beams are inserted between each adjacent pair of the right-eye color pixel region RG and the left-eye color pixel region LG. When the head of the viewer moves in the horizontal direction and the positions of the left eye LE and the right eye RE thereby move as shown in part (b) of FIG. 2, part of the color pixels BG outputting no light beams becomes visible to the left eye LE but part of the right-eye color pixel region RG is still invisible to the left eye LE. Similarly, part of the color pixels BG outputting no light beams becomes visible to the right eye RE but part of the left-eye color pixel region LG is still invisible to the right eye RE. As described above, in the case of part (b) of FIG. 2, even when the head portion of the viewer moves in the horizontal direction and the ranges visible to the left eye LE and the right eye RE thereby move, it possible to suppress crosstalk and increase the viewing range in the horizontal direction in which the stereoscopic viewing is possible by an amount corresponding to the horizontal-direction width of each color pixel BG outputting no light beam (in FIG. 4, one pitch in the horizontal direction of the color pixels).

The effect of insertion of the color pixels BG outputting no light beams can be obtained not only in the case where the head of the viewer moves in the horizontal direction but also in the case where the head of the viewer moves in the vertical direction. Specifically, even when the head of the viewer moves in the vertical direction, it possible to suppress crosstalk and increase the viewing range in the vertical direction in which the stereoscopic viewing is possible by an amount corresponding to the vertical-direction width of each color pixel BG outputting no light beam (in FIG. 4, one pitch in the vertical direction of the color pixels).

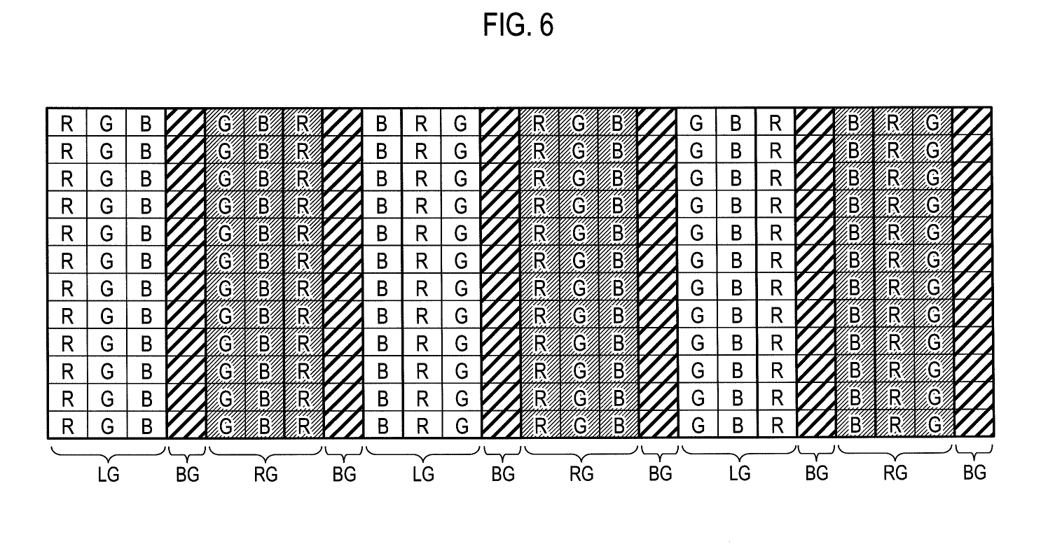

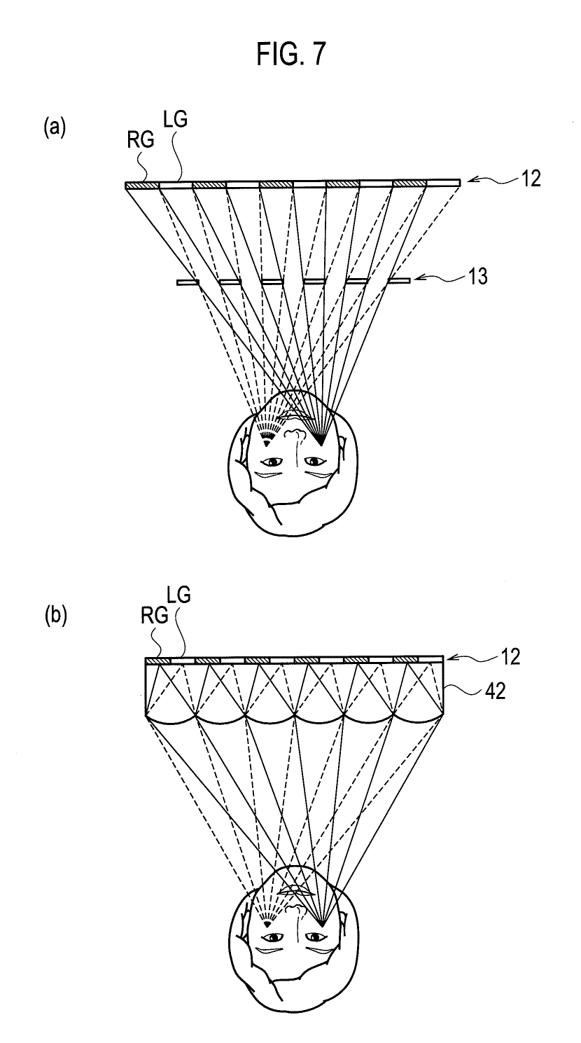

In a comparative example shown in FIG. 6, the right-eye color pixel regions RG, the left-eye color pixel regions LG, and the color pixels BG outputting no light beams are arranged in the vertical direction in the color pixel region shown in FIG. 3. Consideration is made of a case where the movement of the head of the viewer in the horizontal direction causes the ranges visible to the left eye LE and the right eye RE to move in the horizontal direction by a distance equal to or larger than the width of the color pixel BG outputting no light beam, and the crosstalk thereby occurs. In this case, the row of the color pixels of the same color in the right-eye color pixel region RG adjacent to the edges of the color pixels BG outputting no light beams is included in the range visible to the left eye LE. This is the same for the right eye RE. Accordingly, each of the left eye LE and the right eye RE visibly recognizes a linear noise of the same color extending in the vertical direction. At the same time, the row of the color pixels of the same color in the left-eye color pixel region LG adjacent to the edges of the color pixels BG outputting no light beams is located outside the range visible to the left eye LE. This is the same for the right eye RE. As a result, the white balance of the image is disturbed.

On the other hand, in the embodiment of the present invention, since the arrangement direction of the color pixels BG outputting no light beams is inclined, no color pixels of the same color are arranged side by side along the edges of the color pixels BG outputting no light beams. Accordingly, it is possible to suppress a linear noise and disturbance of the white balance occurring in the case where the color pixels BG outputting no light beams are arranged in the vertical direction which is the same as the arrangement direction of the color pixels of the same color, as shown in FIG. 6.

Note that the shape of the color pixels BG outputting no light beams such as the width in the horizontal direction, the width in the veridical direction, and the inclination angle is not limited to that of the embodiment shown in FIG. 4 and may be set depending on the size of the entire color pixel region of the LCD panel 12, the resolution of image, the viewing distance, and the viewing mode. In a case where: the size of the entire color pixel region is large; the resolution of the image is high; and the viewing distance in normal usage is large, no barrier portions 32a are visually recognized even if the width in each of the horizontal direction and the vertical direction are increased, i.e. the number of pitches of the color pixels in each of the horizontal direction and the vertical direction is increased, and natural stereoscopic viewing is possible. Furthermore, stereoscopic viewing corresponding to various viewing distances and viewing modes is made possible by controlling the pattern of the barrier portions 32a in the liquid crystal barrier 13 by using a passive type liquid crystal system or an active matrix type liquid crystal system. Specifically, the pattern of “passive type liquid crystal system” is fixed to a certain shape. Accordingly, several “fixed patterns” are formed in advance as the pattern of the barrier portions 32a and switched from one to another as appropriate according to the viewing distance and the viewing mode. Meanwhile, since the pattern of the active matrix type liquid crystal system is controllable in a unit of a dot of a liquid crystal panel, it is possible to perform control according to more detailed viewing distance and viewing mode than those of “passive liquid crystal display”.

Moreover, the widths respectively in the horizontal direction and vertical direction of each color pixel BG outputting no light beam can be individually controlled to increase the viewing range in the horizontal direction and the vertical direction in which the stereoscopic viewing is possible. Specifically, if you want to suppress the crosstalk in the horizontal direction and increase the viewing range in the horizontal direction in which is the stereoscopic viewing is possible, the horizontal-direction width of each color pixel BG outputting no light beam should be increased. If you want to suppress the crosstalk in the vertical direction and increase the viewing range in the vertical direction in which is the stereoscopic viewing is possible, the vertical-direction width of each color pixel BG outputting no light beam should be increased.

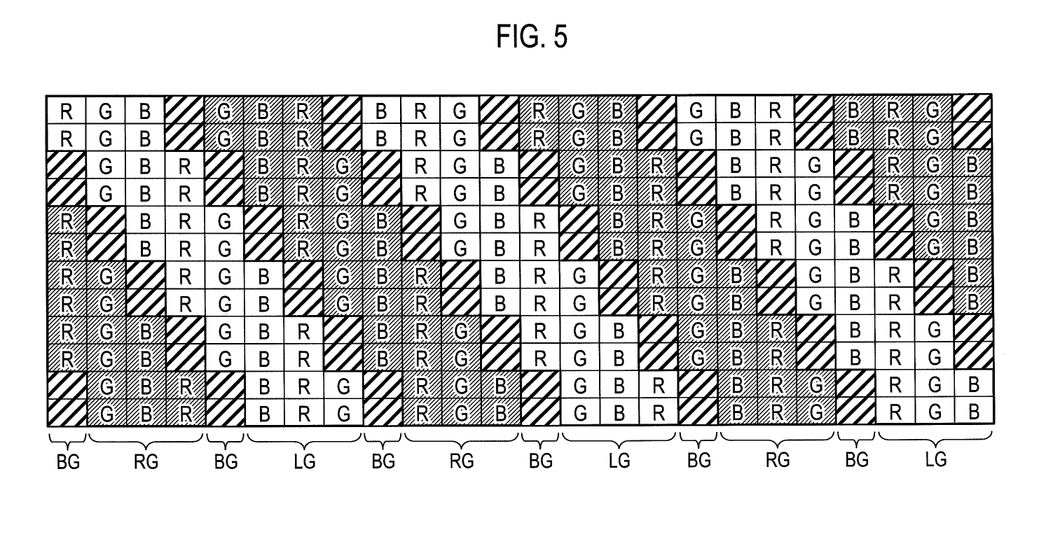

For example, as shown in FIG. 5, the arrangement direction of the color pixels BG outputting no light beams may be inclined at a ratio of one pitch in the horizontal direction of the color pixels to two pitches in the vertical direction of the color pixels. This can increase the vertical-direction width of the color pixels BG outputting no light beams. Accordingly, the arrangement direction of the color pixels BG outputting no light beams is closer to the vertical direction than in the example of the embodiment in FIG. 4. Hence, the crosstalk in the vertical direction is reduced and the viewing range in the vertical direction in which the stereoscopic viewing is possible is increased.

Meanwhile, as shown in FIG. 4, the arrangement direction of the color pixels BG outputting no light beams is inclined at a ratio of one pitch in the horizontal direction of the color pixels to one pitch in the vertical direction of the color pixels. As a result, no color pixels of the same color are adjacent to each other in a row of color pixels arranged along the edges of the color pixels BG outputting no light beams, and the different color pixels can be periodically arranged in a unit of one color pixel. Accordingly, occurrence of a linear noise and disturbance of the white balance can be further suppressed compared to the case of FIG. 5.

Note that, in the embodiment of the present invention described above, the description is given of the example in which the liquid crystal barrier is provided on the front surface side of the LCD panel as viewed from the viewer of the autostereoscopic display apparatus. However, similar effects can be obtained in an autostereoscopic display apparatus provided with the liquid crystal barrier on the back side of the LCD panel (i.e. the front surface side of the back light) as viewed from the viewer. Moreover, in the embodiment of the present invention described above, the description is given of the case where the stereoscopic viewing is performed in the parallax barrier method using the liquid crystal barrier 13 which is an example of the parallax barrier (see part (a) of FIG. 7). However, the present invention can be applied to the case where the stereoscopic viewing is performed in a lenticular method which is another example of the parallax division method of sights (see part (b) of FIG. 7), as in the parallax barrier method. In the lenticular method, like the barrier portions 32a of the liquid crystal barrier 13, a lenticular sheet 42 in which a plurality of cylindrical lenses each having an inclined lens axis are arranged parallel to each other is disposed to face the display surface of the LCD panel 12, instead of the liquid crystal barrier 13.

In the embodiment of the present invention, the description is given of the case of using the LCD panel 12 in which the color pixels of three colors R, G, and B are periodically arranged in the horizontal direction. However, the present invention can be applied to the case in which color pixels of four colors further including Y (yellow) or color pixels of more than four colors are periodically arranged in the horizontal direction.

Although some embodiments of the present invention have been described above, these embodiments are given as examples and do not intend to limit the scope of the invention. These embodiments can be carried out in various other modes and various omissions, replacements, and modifications can be made within the spirit of the invention. These embodiments and modifications thereof are included in the scope and spirit of the invention and are similarly included in the scope of the invention described in the claims and its equivalents.

The autostereoscopic display apparatus in the embodiment of the present invention includes: the display panel configured to display an image by using the light beams outputted from multiple color pixels; and the parallax division part disposed to face the display surface of the display panel. In the display panel, the color pixels of different colors are periodically arranged in the horizontal direction and the color pixels of the same color are arranged in the vertical direction. The parallax division part divides the color pixel region of the display panel into the right-eye color pixel regions RG visible to the right eye of the viewer but invisible to the left eye of the viewer and the left-eye color pixel regions LG visible to the left eye but invisible to the right eye, so that the different images can be viewed respectively from the positions of the right eye and the left eye arranged in the horizontal direction. The color pixels BG outputting no light beams are arranged in the boarder between each adjacent pair of the right-eye color pixel region RG and the left-eye color pixel region LG. Moreover, the arrangement direction of the color pixels BG outputting no light beams is inclined. Since the arrangement direction of the color pixels BG outputting no light beams is inclined, no color pixels of the same color are arranged side by side along the edges of the color pixels BG outputting no light beams. Accordingly, it is possible to suppress a linear noise occurring when the color pixels BG outputting no light beams are arranged in the vertical direction which is the same as the arrangement direction of the color pixels of the same color. Hence, it is possible to suppress occurrence of crosstalk due to moving of the viewpoint and to suppress occurrence of a monochromatic linear noise even if crosstalk should occur. The autostereoscopic display apparatus in the embodiment of the present invention can be thus used in industries.

What is claimed is:

1. An autostereoscopic display apparatus comprising:
a display panel in which color pixels of different colors are periodically arranged in a horizontal direction and color pixels of the same color are arranged in a vertical direction and which is configured to display an image by using light beams outputted from the color pixels; and
a parallax division part which is disposed to face a display surface of the display panel and which divides a color pixel region of the display panel into a right-eye color pixel region visible to the right eye of a viewer but invisible to the left eye of the viewer and a left-eye color pixel region visible to the left eye but invisible to the right eye, so that different images are visible respectively from positions of the right eye and the left eye arranged in the horizontal direction, wherein
color pixels outputting no light beams are arranged in a boundary between the right-eye color pixel region and the left-eye color pixel region, and
an arrangement direction of the color pixels outputting no light beams is inclined.

2. The autostereoscopic display apparatus according to claim 1, wherein the arrangement direction of the color pixels outputting no light beams is inclined at a ratio of one pitch in the horizontal direction of the color pixels to one pitch in the vertical direction of the color pixels.

3. The autostereoscopic display apparatus according to claim 1, wherein the arrangement direction of the color pixels outputting no light beams is inclined at a ratio of one pitch in the horizontal direction of the color pixels to two pitches in the vertical direction of the color pixels.
